(19) United States
(12) Patent Application Publication
(10) Pub. No.: US 2025/0362201 A1
(43) Pub. Date: Nov. 27, 2025

(54) CALIBRATION PLATE FOR DETECTING A SUBSURFACE DEPTH AND PREPARATION METHOD THEREFOR

(71) Applicant: National Institute of Metrology, China, Beijing (CN)

(72) Inventors: Shu ZHANG, Beijing (CN); Yushu SHI, Beijing (CN); Kang WANG, Beijing (CN); Lei PI, Beijing (CN)

(21) Appl. No.: 19/027,511

(22) Filed: Jan. 17, 2025

(30) Foreign Application Priority Data
May 24, 2024 (CN) 202410649644.7

(51) Int. Cl. G01M 11/02

(52) U.S. Cl. CPC G01M 11/0214; G01M 11/0264

(57) ABSTRACT

A calibration plate for detecting a subsurface depth and a preparation method therefor are provided, relating to the field of optical calibration. The calibration plate includes wedged glass, sample particles, and a fixing device. The wedged glass includes a first side surface and a second side surface which are parallel to each other, a first planar surface and a second planar surface which are perpendicular to each other, and one inclined surface. The first side surface and the second side surface each are connected to the first planar surface, the second planar surface and the inclined surface. The inclined surface is connected to the first planar surface and the second planar surface; and the second planar surface is fixedly connected to the fixing device. The first planar surface is parallel to a horizontal plane, and the sample particles are uniformly attached to the inclined surface.

### CROSS-REFERENCE TO RELATED APPLICATION

This patent application claims the benefit and priority of Chinese Patent Application No. 202410649644.7 filed with the China National Intellectual Property Administration on May 24, 2024, the disclosure of which is incorporated by reference herein in its entirety as part of the present application.

### TECHNICAL FIELD

The present disclosure relates to the field of optical calibration, and in particular to a calibration plate for detecting a subsurface depth, and a preparation method therefor.

### BACKGROUND

In recent years, with the rapid development of the research on micro-nano field and astronomical optics, the optical measurement system required is becoming more and more complex, the optical elements involved are becoming more and more precise; and meanwhile, there are also higher and higher requirements for the manufacturing ability for the modern optical elements. However, in the field of optical element manufacturing and processing, the indexes for evaluating precision optical elements include not only surface quality and surface accuracy, but also subsurface quality of the elements. Cutting, grinding, polishing and other technologies are needed in the processing of the precision optical elements, and these processing technologies are easy to form defects on the surface and subsurface of the optical elements, with horizontal dimensions ranging from tens of nanometers to several microns, and vertical depth dimensions usually ranging from several microns to several hundred microns. These defects seriously affect the performance and service life of the optical elements. For example, the defects of lens may lead to defocusing, astigmatism, distortion, and the like, seriously affecting the performance of lasers and lithography machines. The subsurface defects of the optical elements in some space telescope systems will further expand due to long-term exposure to space environment, affecting the surface accuracy of the mirror. Therefore, the study of how to remove the subsurface defects of optical elements has become an important research issue in the field of optical processing, and the primary goal of removing the subsurface defects is to achieve accurate detection and location of defects.

Non-destructive testing is usually used to detect the defects of precision optical elements, because the detection signal is complex and changeable after undergoing reflection, refraction, scattering and the like inside an object, the defects are diverse and similar in characteristics. Due to the fact that the tested materials are different and have different characteristics, it is often difficult to accurately identify defect depth information hidden in the subsurface of elements, and the reliability, accuracy and efficiency for depth positioning detection need to be improved.

Due to the lack of calibration of a subsurface detection depth of the optical element, it is impossible to calibrate a depth measurement function of a subsurface defect detection instrument such as a laser confocal scanning microscope, so a calibration plate with wide applicability and high reliability and a preparation method therefor are needed to fill this blank.

### SUMMARY

An objective of the present disclosure is to provide a calibration plate for calibrating a subsurface depth and a preparation method therefor. The reliability of calibrating the subsurface detection depth of an optical element can be improved.

To achieve the objective above, the present disclosure provides the following solutions: a calibration plate for detecting a subsurface depth includes wedged glass, sample particles, and a fixing device.

The wedged glass includes a first side surface and a second side surface which are parallel to each other, a first planar surface and a second planar surface which are perpendicular to each other, and one inclined surface. The first side surface and the second side surface each are connected to the first planar surface, the second planar surface and the inclined surface. The inclined surface is connected to the first planar surface and the second planar surface.

The second planar surface is fixedly connected to the fixing device.

The sample particles are uniformly attached to the inclined surface, and the sample particles are microsphere particles.

Alternatively, the fixing device includes a wedged glass mounting seat, and a mounting plate.

The wedged glass mounting seat is provided with a clamping groove, the clamping groove is provided with an opening in an upper surface of the wedged glass mounting seat, and the second planar surface is inserted into the clamping groove from the opening.

The mounting plate is arranged on the first planar surface and an upper surface of the wedged glass mounting seat, and the wedged glass is fixedly connected to the wedged glass mounting seat through the mounting plate.

Alternatively, after the wedged glass is inserted into the clamping groove, and the inclined surface is attached to a bottom surface of the clamping groove. The bottom surface is one side, opposite to the opening, of the clamping groove.

Alternatively, the wedged glass is wedged K9 glass.

Alternatively, the sample particles are spherical in shape. A diameter of the standard sample particle is integer multiples of the resolution of an electron microscope.

Alternatively, the wedged glass has roughness of 5 nm-12 nm.

Alternatively, the sample particles are polystyrene microsphere particles, cadmium sulfate nanomicrosphere particles, or colloidal gold particles.

Alternatively, the first planar surface is provided with a calibration line, a start line of the calibration line starts from a tip position of the wedged glass, and the calibration line is perpendicular to the first side surface and the second side surface.

A preparation method for a calibration plate for detecting a subsurface depth is applied to the calibration plate for detecting the subsurface depth. The preparation method includes selecting or preparing a piece of wedged glass, evaluating surface roughness of the wedged glass using a surface roughness measurement instrument, where the roughness of the wedged glass ranges from 5 nm to 12 nm.

Shape parameters of the wedged glass are calibrated using a high-precision micro-nano coordinate measurement machine, where the shape parameters include an inclination angle, and a height.

Standard sample particles are selected or prepared, where a diameter of the standard sample particle is an integer multiple of the resolution of an electron microscope.

The standard sample particles with a same diameter are uniformly attached onto an inclined surface of the wedged glass, where the standard sample particles are arranged in a single row or multiple rows parallel to a side edge of the inclined surface, and the side edge of the inclined surface is hypotenuse of a triangular side surface of the wedged glass.

A calibration line is set on the first planar surface for observation and positioning, where the first planar surface is a surface connected to the inclined surface through a tip position of the wedged glass, and a start line of the calibration line starts from the tip position of the wedged glass.

Finally, a fixing device is prepared according to the shape parameters of the wedged glass, and fixing the wedged glass and the fixing device to obtain a calibration plate.

Alternatively, the sample particles are at least one of polystyrene microsphere particles, cadmium sulfate nanomicrosphere particles, and colloidal gold particles.

According to specific embodiments of the present disclosure, the present disclosure has the following technical effects: the calibration plate for detecting a subsurface depth includes wedged glass, sample particles, and a fixing device. The wedged glass includes a first side surface and a second side surface which are parallel to each other, a first planar surface and a second planar surface which are perpendicular to each other, and one inclined surface. The first side surface and the second side surface each are connected to the first planar surface, the second planar surface and the inclined surface. The inclined surface is connected to the first planar surface and the second planar surface. The second planar surface is fixedly connected to the fixing device. The sample particles are uniformly attached to the inclined surface. The sample particles are microsphere particles. By adopting a wedged structure, the subsurface depth is gradually deepened, and the accuracy and reliability of detecting the subsurface depth are improved.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural diagram of a calibration plate for detecting a subsurface depth according to the present disclosure;

FIG. 2 is a schematic diagram of testing principle of a calibration plate according to the present disclosure;

FIG. 3 is a schematic diagram of a testing process of a calibration plate according to the present disclosure.

In the drawings: 1—wedged glass; 2—sample particle; 3—wedged glass mounting seat; 4—mounting plate; 5—calibration line.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a calibration plate for calibrating a subsurface depth and a preparation method therefor. The reliability of calibrating the subsurface detection depth of an optical element can be improved. Moreover, the shortcomings that the locating limit of the subsurface depth is difficult to determine and the depth positioning information is low in reliability in the existing subsurface defect detection technology are overcome.

In order to make the objectives, features and advantages of the present disclosure more clearly, the present disclosure is further described in detail below with reference to the accompanying drawings and specific embodiments.

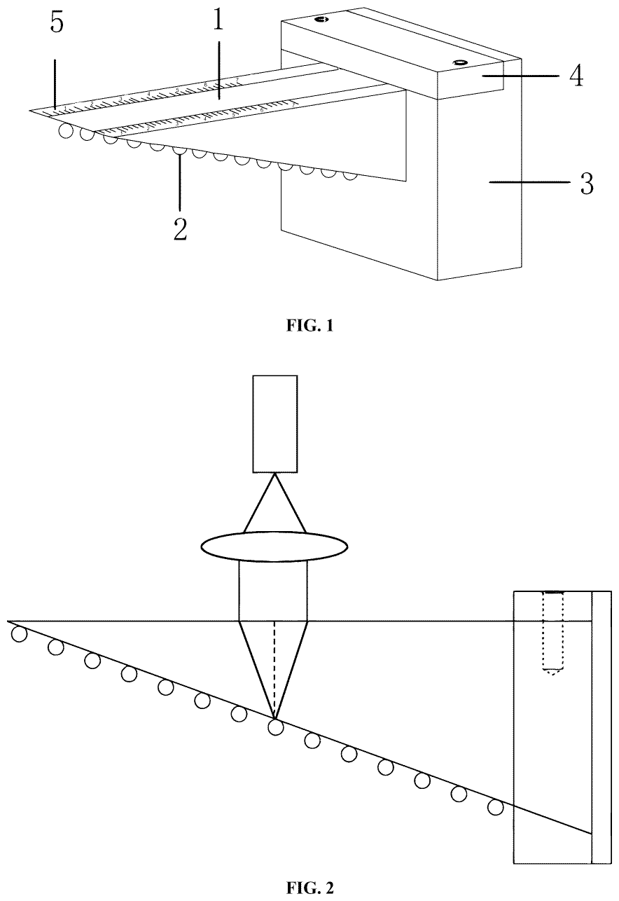

Embodiment 1: As shown in FIG. 1, the present disclosure provides a calibration plate for detecting a subsurface depth, which includes wedged glass 1, sample particles 2, and a fixing device.

The wedged glass 1 includes a first side surface and a second side surface which are parallel to each other, a first planar surface and a second planar surface which are perpendicular to each other, and one inclined surface. The first side surface and the second side surface each are connected to the first planar surface, the second planar surface and the inclined surface. The inclined surface is connected to the first planar surface and the second planar surface.

The second planar surface is fixedly connected to the fixing device.

In practical application, when detecting the subsurface depth, the first planar surface of the calibration plate needs to be placed horizontally.

The sample particles 2 are uniformly attached to the inclined surface. The sample particles 2 are microsphere particles. Specifically, the sample particles should be located in the middle of calibration lines on both sides. The purpose of the calibration line is to specify the position of the sample particles, thus finding the sample particles conveniently when using a sample plate, and indicating a measurement position of an instrument to be calibrated. The sample particles need to be arranged from a sharp tip.

The fixing device includes a wedged glass mounting seat 3, and a mounting plate 4.

The wedged glass mounting seat 3 is provided with a clamping groove, the clamping groove is provided with an opening in an upper surface of the wedged glass mounting seat 3, and the second planar surface is inserted into the clamping groove from the opening.

The mounting plate 4 is arranged on the first planar surface and an upper surface of the wedged glass mounting seat 3. The wedged glass is fixedly connected to the wedged glass mounting seat 3 through the mounting plate 4.

Further, after the wedged glass 1 is inserted into the clamping groove, and the inclined surface is attached to a bottom surface of the clamping groove. The bottom surface is one side, opposite to the opening, of the clamping groove. That is, the inclined surface of the wedged glass 1 coincides with the inclined surface of the clamping groove of the wedged glass mounting seat 3.

As a specific embodiment, the wedged glass 1 is wedged K9 glass.

As a specific embodiment, the sample particles 2 are spherical in shape. A diameter of the standard sample particle is an integer multiple of the resolution of an electron microscope. The electron microscope is an electron microscope with the function of accurately measuring particle diameter. The function of electron microscope is to accurately measure the particle diameter, thus serving the subsequent calibration of other instruments through the diameter data. The reason that the diameter is an integer multiple of the resolution is to make the particle diameter measurement more accurate.

As a specific embodiment, the wedged glass 1 has a roughness of 5 nm-12 nm.

As a specific embodiment, the sample particles 2 are polystyrene microsphere particles, cadmium sulfate nanomicrosphere particles, or colloidal gold particles. That is, the sample particles 2 are at least one of the polystyrene microsphere particles, the cadmium sulfate nanomicrosphere particles, or the colloidal gold particles, which are single particles rather than mixed particles.

As a specific embodiment, the first planar surface is provided with calibration lines 5. The calibration lines are distributed on left and right sides of the first planar surface, and symmetrically distributed along a center line of the first planar surface. A numerical value is marked every five calibration lines, and the numerical value of the calibration line is a horizontal distance between the calibration line and the tip.

The following provides a method for detecting the subsurface depth, and the method includes the following Step S1 to Step S3.

Step S1. A subsurface depth calibration plate is placed on a stage of an instrument to be calibrated, and a position and an angle of a calibration plate are adjusted to ensure that the calibration plate is placed horizontally and an upper surface of wedged glass of the calibration plate is perpendicular to a lens of the instrument, and a side surface of the wedged glass 1 is parallel to a movement direction of the stage of the instrument to be calibrated. The stage of the instrument to be calibrated is moved until the wedged glass reaches the lens of the instrument, such that the instrument to be calibrated can just detect a tip position of the wedged glass 1.

Step S2. The stage is moved, and when the instrument to be calibrated just cannot accurately detect the diameter of sample particles 2 attached on an inclined surface thereof through the wedged glass 1, the movement of the stage is stopped, and a numerical value of the calibration line at an in-focus position of the instrument to be calibrated is recorded at this time.

Step S3. According to an included angle between the first planar surface and the second planar surface of the wedged glass of the calibration plate and the marking line value, a depth value is calculated by applying a trigonometric function. According to the marking line value, a moving distance of the calibration plate from a start end of a tip relative to the instrument to be calibrated can be obtained, and the maximum depth value capable of being measured by the instrument to be calibrated can be calculated according to an angle value of the tip when designing the calibration plate and the functional relationship of tangency.

According to the present disclosure, the calibration of the subsurface detection depth by the calibration plate is to convert the calculation of a subsurface limit depth calibration value into the calculation of a horizontal direction displacement value by observing the standard sample particles.

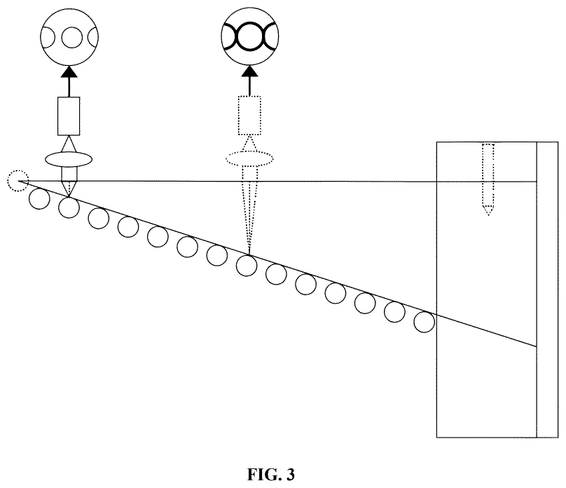

In practical application, the specific process of performing subsurface depth detection by applying the method for detecting the subsurface depth is as shown in FIG. 2 and FIG. 3, as described in Step 201 to Step 205.

Step 201. A subsurface depth calibration plate is placed on a stage of an instrument to be calibrated, and a position and an angle of the stage are adjusted to ensure that the calibration plate is placed horizontally and an upper surface of the wedged glass of the calibration plate is perpendicular to a lens of the instrument, and a side surface of the wedged glass 1 is parallel to a movement direction of the stage of the instrument to be calibrated.

Step 202. The subsurface depth calibration plate is placed below the lens of the instrument to be calibrated, the stage of the instrument to be calibrated is moved until the wedged glass reaches the lens of the instrument, such that the instrument to be calibrated can just detect the tip of the wedged glass 1.

Step 203. The stage is continuously moved. The stage can be continuously moved if the instrument to be calibrated can clearly detect the sample particles 2 attached to the inclined surface of the wedged glass 1 through the wedged glass 1. If the instrument to be calibrated can clearly detect the sample particles 2 attached on its inclined surface through the wedged glass 1, continue to move the stage. When the instrument to be calibrated just cannot accurately detect the diameter of sample particles 2 attached on its inclined surface through the wedged glass 1, the movement of the stage is stopped.

Step 204. A marking line value X of a calibration sample plate is calibrated at a measurement position of the instrument to be calibrated at this time.

Step 205. Because of the tangent relationship between X and the depth value, a limit depth of the subsurface capable of being accurately detected by the instrument to be calibrated can be calculated according to the inclination angle of the wedged glass.

According to a use method of the subsurface detection depth calibration plate provided by the present disclosure, the gradual measurement of the subsurface detection depth can be achieved by changing the sample particles with different depths detected by the instrument to be calibrated.

Embodiment 2: The present disclosure further provides a preparation method for a calibration plate for detecting a subsurface depth. The preparation method is applied to the calibration plate for detecting a subsurface depth according to Embodiment 1, and the preparation method includes the following steps:

A piece of wedged glass is selected or prepared, a surface roughness of the wedged glass is evaluated using a surface roughness measurement instrument, where the roughness of the wedged glass ranges from 5 nm to 12 nm.

Shape parameters of the wedged glass are calibrated using a high-precision micro-nano coordinate measurement machine, where the shape parameters include an inclination angle, and a height.

Standard sample particles are selected or prepared, where a diameter of the standard sample particle is an integer multiple of the resolution of an electron microscope.

The standard sample particles with the same diameter are uniformly attached to an inclined surface of the wedged glass, where the standard sample particles are arranged in a single row or multiple rows parallel to a side edge of the inclined surface, and the side edge of the inclined surface is hypotenuse of a triangular side surface of the wedged glass.

A calibration line is set on the first planar surface for observation and positioning. The first planar surface is a surface connected to the inclined surface through the tip position of the wedged glass, and the start line of the calibration line starts from the tip position of the wedged glass.

A fixing device is prepared according to the shape parameters of the wedged glass, and the wedged glass and the fixing device are fixed to obtain a calibration plate.

The sample particles are at least one of polystyrene microsphere particles, cadmium sulfate nanomicrosphere particles, or colloidal gold particles.

Further, a termination line of the calibration line is at a position on the first planar surface corresponding to the position where the standard sample particles are not attached.

In practical application, the preparation process of the calibration plate of the present disclosure is as described in Step 101 to Step 105.

Step 101. A piece of wedge-shaped K9 glass is selected or prepared, a surface roughness measurement instrument is used to evaluate the surface roughness of the wedge-shaped K9 glass, which should range from 5 nm to 12 nm, such that the surface physical state of a high-precision optical element can be well simulated. A high-precision micro-nano coordinate measurement machine is used to calibrate shape parameters such as an inclination angle and a height, and the above values can be recorded for subsequent processing of corresponding device devices and calculation of detection depth parameters of the instrument to be calibrated.

Step 102. The sample particles 2, such as polystyrene microsphere particles, cadmium sulfate nanomicrosphere particles, colloidal gold particles and other standard particles with regular morphology, uniform size and good adsorbability, can be selected or prepared. The diameter of the selected and prepared standard sample particle 2 should be an integer multiple of the resolution of the electron microscope, so as to ensure that the electron microscope can obtain a clear particle morphology and structure when calibrating the depth parameters. The electron microscope is used to calibrate the diameter of the particle, and in this step, the particle diameter can be changed to represent subsurface defects with different sizes.

Step 103. The sample particles 2 with the same radius are uniformly attached to the inclined surface of the wedged glass 1, and arranged in a single row to be parallel to a straight line of a side edge of the inclined surface, or uniformly arranged in multiple rows to uniformly cover the inclined surface. The particles in the same row should be arranged in a straight line with the same spacing as far as possible. Calibration lines are distributed on the left and right sides of the first planar surface and symmetrically distributed along a center line of the first planar surface. A numerical value is marked every fifth calibration lines, and the marking line value is a horizontal distance between the calibration line and the tip.

Step 104. The wedged glass mounting seat 3 is prepared according to the shape parameters of the wedged glass 1, the wedged glass 1 is inserted into the wedged glass mounting seat 3, and the wedged glass 1 is fixed through the mounting plate 4 to ensure that the side surface of the wedged glass 1 is horizontal, at this time, the depth information of the subsurface defects can be obtained by detecting the depth of sample particles 2 from the upper surface of the wedged glass 1.

Step 105. According to the three-dimensional size of the prepared subsurface detection depth calibration plate, a rectangular container is prepared for storing the prepared sample plate.

Compared with the prior art, the present disclosure has the following advantages and outstanding technical results:
1. A wedge-shaped structure is adopted to gradually deepen the subsurface depth, such that the minimum resolution of a calibration result can be calculated from the inclination angle of the wedged glass.
2. The depth detection of the subsurface is transformed into the depth detection of the sample particles, which greatly reduces the difficulty of detection and improves the detection speed and accuracy.
3. The adopted K9 glass material has good transmittance and low reflectivity, and there are no defects such as bubbles and water waves inside, which can reduce the calibration error caused by the material.
4. The preparation process of the calibration plate is simple, and the preparation and processing technology of the K9 glass material is mature. The calibration plate with a wide depth range can be manufactured to meet the depth calibration requirements of most instruments, and meanwhile, the surface depth of the instrument can be gradually measured, which makes the calibration result closer to a true value and has high reliability.

Various embodiments in this specification are described in a progressive way, and each embodiment focuses on a difference from the other embodiments. The same and similar parts between the various embodiments can only be referred to each other.

Specific examples are used herein for illustration of the principles and embodiments of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A calibration plate for detecting a subsurface depth, comprising:
wedged glass having a first side surface and a second side surface parallel to each other, a first planar surface and a second planar surface perpendicular to each other, and one inclined surface connected to the first planar surface and the second planar surface, the first side surface and the second side surface each are connected to the first planar surface, the second planar surface and the inclined surface;
sample particles comprising microsphere particles are uniformly attached to the inclined surface, and
a fixing device, the second planar surface being fixedly connected to the fixing device.

2. The calibration plate for detecting a subsurface depth according to claim 1, wherein the fixing device comprises:
a wedged glass mounting seat provided with a clamping groove, the clamping groove is provided with an opening in an upper surface of the wedged glass mounting seat, and the second planar surface is inserted into the clamping groove from the opening; and
a mounting plate arranged on the first planar surface and an the upper surface of the wedged glass mounting seat, wherein the wedged glass is fixedly connected to the wedged glass mounting seat through the mounting plate.

3. The calibration plate for detecting a subsurface depth according to claim 2, wherein after the wedged glass is inserted into the clamping groove, the inclined surface is attached to a bottom surface of the clamping groove, and the bottom surface is one side, opposite to the opening, of the clamping groove.

4. The calibration plate for detecting a subsurface depth according to claim 1, wherein the wedged glass comprises wedged K9 glass.

5. The calibration plate for detecting a subsurface depth according to claim 1, wherein the sample particles are spherical in shape.

6. The calibration plate for detecting a subsurface depth according to claim 1, wherein the wedged glass has roughness of 5 nm-12 nm.

7. The calibration plate for detecting a subsurface depth according to claim 1, wherein the sample particles are one selected from a group consisting of polystyrene microsphere particles, cadmium sulfate nanomicrosphere particles, and colloidal gold particles.

8. The calibration plate for detecting a subsurface depth according to claim 1, wherein the first planar surface is provided with a calibration line, a start line of the calibration line starts from a tip position of the wedged glass, and the calibration line is perpendicular to the first side surface and the second side surface.

9. A preparation method for the calibration plate for detecting a subsurface depth according to claim 1, the method comprising:
selecting or preparing a piece of wedged glass, evaluating surface roughness of the wedged glass using a surface roughness measurement instrument, wherein the roughness of the wedged glass ranges from 5 nm to 12 nm;
calibrating shape parameters of the wedged glass using a high-precision micro-nano coordinate measurement machine, wherein the shape parameters comprise an inclination angle, and a height;
selecting or preparing standard sample particles, wherein a diameter of the standard sample particle is an integer multiple of resolution of an electron microscope;
uniformly attaching the standard sample particles with a same diameter onto an inclined surface of the wedged glass, wherein the standard sample particles are arranged in a single row or multiple rows parallel to a side edge of the inclined surface, and the side edge of the inclined surface is a hypotenuse of a triangular side surface of the wedged glass;
setting a calibration line on a first planar surface for observation and positioning, wherein the first planar surface is a surface connected to an inclined surface through a tip position of the wedged glass, and a start line of the calibration line starts from the tip position of the wedged glass; and
preparing a fixing device according to the shape parameters of the wedged glass and fixing the wedged glass and the fixing device to obtain a calibration plate.

10. The preparation method for a calibration plate for detecting a subsurface depth according to claim 9, wherein the fixing device includes a wedged glass mounting seat, and a mounting plate;
the wedged glass mounting seat is provided with a clamping groove, the clamping groove is provided with an opening in an upper surface of the wedged glass mounting seat, and the second planar surface is inserted into the clamping groove from the opening;
the mounting plate is arranged on the first planar surface and an upper surface of the wedged glass mounting seat, and the wedged glass is fixedly connected to the wedged glass mounting seat through the mounting plate.

11. The preparation method for a calibration plate for detecting a subsurface depth according to claim 10, wherein after the wedged glass is inserted into the clamping groove, the inclined surface is attached to a bottom surface of the clamping groove, and the bottom surface is one side opposite to the opening of the clamping groove.

12. The preparation method for a calibration plate for detecting a subsurface depth according to claim 11, wherein the wedged glass is wedged K9 glass.

13. The preparation method for a calibration plate for detecting a subsurface depth according to claim 12, wherein the sample particles are spherical in shape.

14. The preparation method for a calibration plate for detecting a subsurface depth according to claim 13, wherein the wedged glass has roughness of 5 nm-12 nm.

15. The preparation method for a calibration plate for detecting a subsurface depth according to claim 14, wherein the sample particles are one selected from a group consisting of polystyrene microsphere particles, cadmium sulfate nanomicrosphere particles, and colloidal gold particles.

16. The preparation method for a calibration plate for detecting a subsurface depth according to claim 15, further comprising providing the first planar surface with a calibration line, a start line of the calibration line starts from a tip position of the wedged glass, and the calibration line is perpendicular to the first side surface and the second side surface.

17. The preparation method for a calibration plate for detecting a subsurface depth according to claim 9, wherein the sample particles are at least one selected from a group consisting of polystyrene microsphere particles, cadmium sulfate nanomicrosphere particles, and colloidal gold particles.
